(19) United States
(12) Patent Application Publication
(10) Pub. No.: US 2024/0268482 A1
(43) Pub. Date: Aug. 15, 2024

(54) AEROSOL PROVISION SYSTEM

(71) Applicant: NICOVENTURES TRADING LIMITED, Longon (GB)

(72) Inventor: Patrick Moloney, London (GB)

(21) Appl. No.: 18/568,648

(22) PCT Filed: Jun. 24, 2022
(86) PCT No.: PCT/GB2022/051627

§ 371 Date: Dec. 8, 2023

(30) Foreign Application Priority Data
Jun. 25, 2021 (GB) 2109225.9

(51) Int. Cl. A24F 40/60; A24F 40/10; A24F 40/53; G01C 21/34; G01C 21/36

(52) U.S. Cl. CPC A24F 40/60; A24F 40/10; A24F 40/53; G01C 21/3476; G01C 21/3682

(57) ABSTRACT

An information provision system (300) comprising an aerosol provision device (1) for generating an aerosol, and a user output device (200) for outputting information to a user of the aerosol provision device (1). The information may comprise a prompt (202) for the user to navigate to a predetermined location (204), which may be a virtual location or a geographical location. The information provision system (300) may be configured to generate the information in the event the information provision system (300) determines that a predetermined criterion is satisfied. Such a predetermined criterion could be the information provision system (300) detecting that a timer exceeds a predetermined time, or possibly the information provision system (300) determining that sensor data from a sensor (91;93;95) of the aerosol generating device (1) is indicative of an adverse event.

### FIELD

The present disclosure relates to aerosol provision systems such as, but not limited to, nicotine delivery systems (e.g. electronic cigarettes and the like).

### BACKGROUND

Electronic aerosol provision systems, often employ an electronic cigarette (e-cigarette) or more generally an aerosol provision device. Such an aerosol provision device typically contains aerosolisable material, such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise an aerosol provision device comprising a vaporiser, e.g. a heating element, arranged to vaporise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision device.

A potential drawback of existing aerosol provision systems and associated aerosol provision devices is that they can often provide insufficient user feedback for indicating to the user a need to take action in response to an event occurring on, or relating to/around, the aerosol provision device. This can then cause problems through the aerosol provision device then being used in ways it should not, and/or used in instances which are not as optimal as they might otherwise be.

Various approaches are described herein which seek to help address or mitigate some of the issues discussed above.

### SUMMARY

According to a first aspect of certain embodiments there is provided an information provision system comprising:
an aerosol provision device for generating an aerosol; and
a user output device for outputting information to a user of the aerosol provision device;
wherein the information provision system is configured to generate the information, and output the information on the user output device, wherein the information comprises a prompt for the user to navigate to a predetermined location.

According to a second aspect of certain embodiments there is provided a method of outputting information to a user of an aerosol provision device for generating an aerosol, the method comprising:
generating information comprising a prompt for a user of the aerosol provision device to navigate to a predetermined location; and
outputting the information on a user output device.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision device comprising a cartridge and control unit (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision device of FIG. 1;

FIGS. 4A and 4B schematically represent a perspective view and a plan view of a dividing wall element of the cartridge of the aerosol provision device of FIG. 1;

FIGS. 5A to 5C schematically represent two perspective views and a plan view of a resilient plug of the cartridge of the aerosol provision device of FIG. 1;

FIGS. 6A and 6B schematically represent a perspective view and a plan view of a bottom cap of the cartridge of the aerosol provision device of FIG. 1;

FIG. 7 schematically represents embodiments of an information provision system, useable with an aerosol provision device such as that shown in FIGS. 1-6B, and comprising a user output device in the form of a display;

FIG. 8A schematically represents a display, from the information provision system in FIG. 7, and which is outputting information, in accordance with some embodiments;

FIG. 8B schematically represents a display, from the information provision system in FIG. 7, and which is outputting information, in accordance with some embodiments;

FIG. 9 schematically represents a display, from the information provision system in FIG. 7, and which is outputting information, in accordance with some embodiments;

FIG. 10 schematically represents a display, from the information provision system in FIG. 7, and which is outputting information, in accordance with some embodiments;

FIG. 11 schematically represents a display, from the information provision system in FIG. 7, and which is outputting information, in accordance with some embodiments;

FIG. 12 schematically represents a display, from the information provision system in FIG. 7, and which is outputting information, in accordance with some embodiments; and

FIG. 13 schematically represents a display, from the information provision system in FIG. 7, and which is outputting information, in accordance with some embodiments.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision devices (such as an e-cigarette) which are used as part of a wider aerosol provision system. According to the present disclosure, a “non-combustible” aerosol provision device is one where a constituent aerosolisable material of the aerosol provision device (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision device. An electronic cigarette may also known as a vaping device or electronic nicotine delivery system (END), although it is noted that the presence of nicotine in the aerosolisable material is not a requirement.

In some embodiments, the aerosol provision device is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision device may comprise a cartridge/consumable part and a body/reusable part, which is configured to releasably engage with the cartridge/consumable part.

The aerosol provision device may be provided with a means for powering a vaporiser therein, and there may be provided an aerosolisable material transport element for receiving the aerosolisable material that is to be vaporised. The aerosol provision device may also be provided with a reservoir for containing aerosolisable material, and in some embodiments a further reservoir for containing flavouring material for flavouring a generated vapour from the aerosol provision device.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision devices (e-cigarettes) may often comprise a modular assembly including both a reusable part (body) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

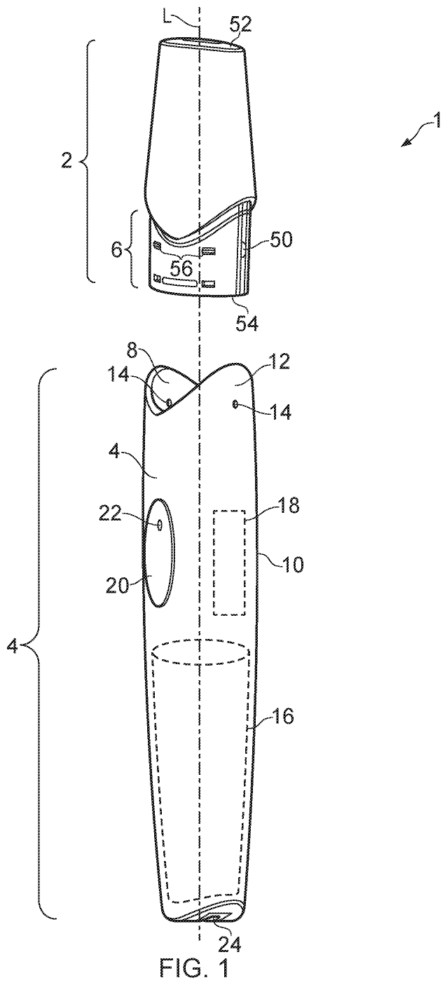

From the forgoing therefore, and with reference to FIG. 1 is a schematic perspective view of an example aerosol provision system/device (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 comprises two main components, namely a cartridge 2 and a control unit 4. The control unit 4 and the cartridge 2 are shown separated in FIG. 1, but are coupled together when in use.

The cartridge 2 and control unit 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece end 52 and an interface end 54 and is coupled to the control unit by inserting an interface end portion 6 at the interface end of the cartridge into a corresponding receptacle 8/receiving section of the control unit. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the control unit. An electrical connection is established between the control unit and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a control unit at all, for example because the transfer of electrical power from the reusable part to the cartridge may be wireless (e.g. based on electromagnetic induction techniques).

The electronic cigarette 1 (aerosol provision device) has a generally elongate shape extending along a longitudinal axis L. When the cartridge is coupled to the control unit, the overall length of the electronic cigarette in this example (along the longitudinal axis) is around 12.5 cm. The overall length of the control unit is around 9 cm and the overall length of the cartridge is around 5 cm (i.e. there is around 1.5 cm of overlap between the interface end portion 6 of the cartridge and the receptacle 8 of the control unit when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The control unit 4 may in accordance with certain embodiments of the disclosure be broadly conventional in terms of its functionality and general construction techniques. In the example of FIG. 1, the control unit 4 comprises a plastic outer housing 10 including the receptacle wall 12 that defines the receptacle 8 for receiving the end of the cartridge as noted above. The outer housing 10 of the control unit 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the control unit in two different orientations. The receptacle wall 12 includes two control unit air inlet openings 14 (i.e. holes in the wall). These openings 14 are positioned to align with an air inlet 50 for the cartridge when the cartridge is coupled to the control unit. A different one of the openings 14 aligns with the air inlet 50 of the cartridge in the different orientations. It will be appreciated some implementations may not have any degree of rotational symmetry such that the cartridge is couplable to the control unit in only one orientation while other implementations may have a higher degree of rotational symmetry such that the cartridge is couplable to the control unit in more orientations.

The control unit further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

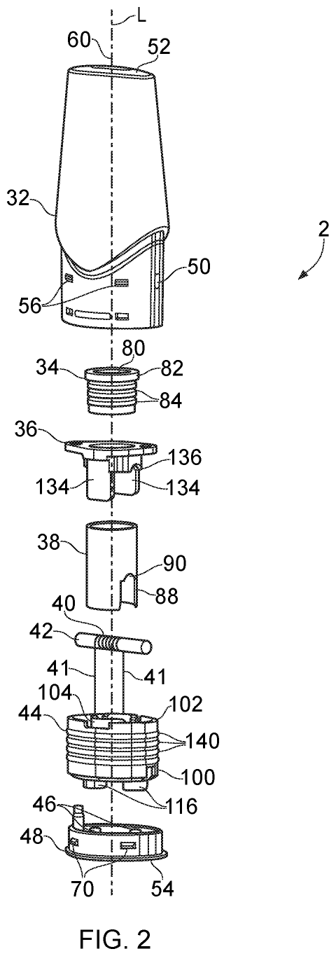

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46.

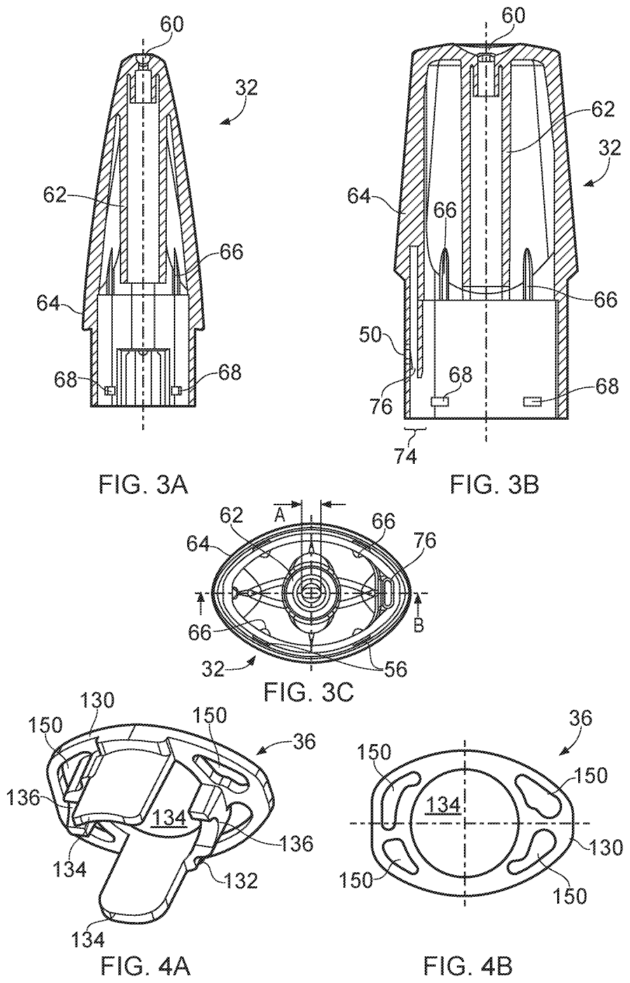

FIGS. 3 to 6 schematically represents some of these components in more detail. FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

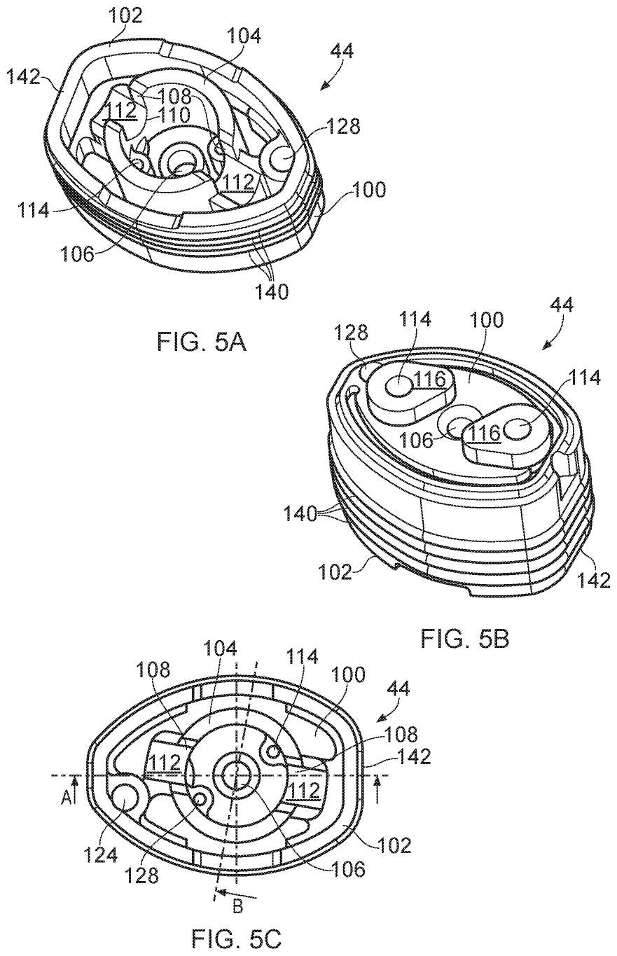

FIG. 4A is a schematic perspective view of the dividing wall element 36 as seen from below. FIG. 4B is a schematic cross-section through an upper part of the dividing wall element 36 as viewed from below.

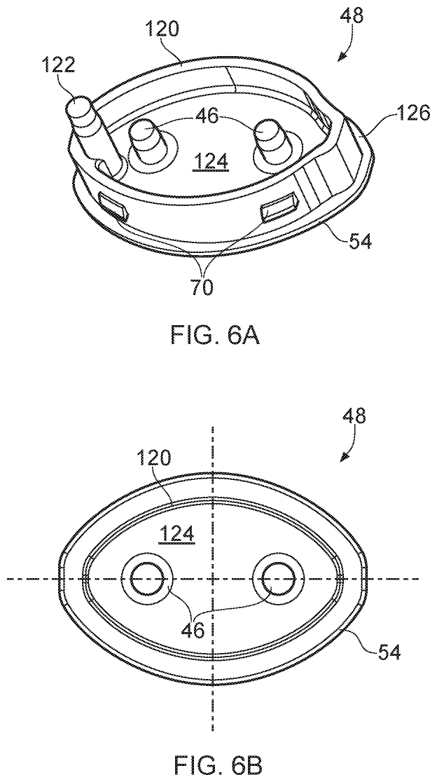

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

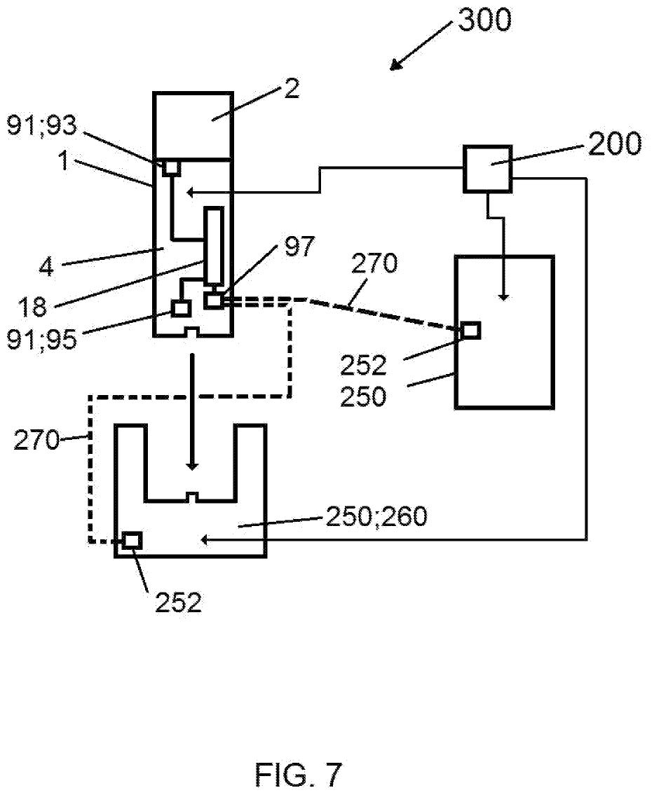

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60 in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the control unit. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to a control unit. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the control unit connect when the cartridge is assembled and connected to the control unit. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the control unit 4 and the control unit activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever control unit air inlet 14 aligns with the air inlet 50 of the cartridge (which will depend on the orientation in which the cartridge was inserted into the control unit receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision device 1 which is configured for generating an aerosol, which is suitable for use in the context of the present disclosure.

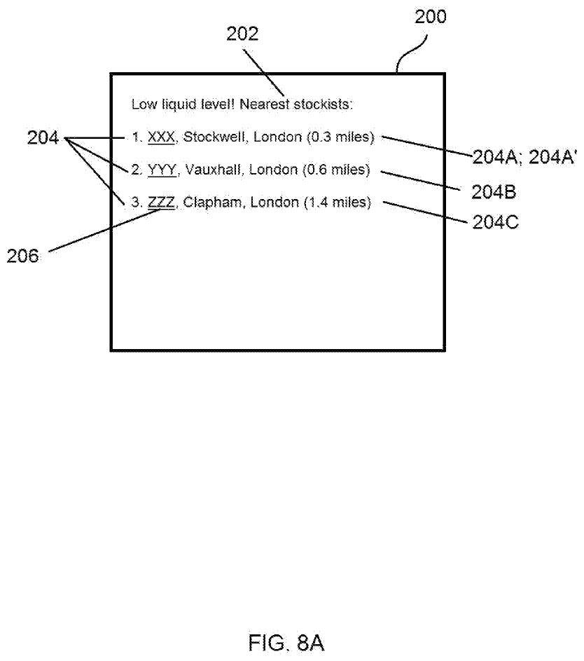

Turning now to FIGS. 7-10, the present disclosure also provides for an information provision system 300 comprising the aerosol provision device 1 for generating an aerosol, and a user output device, such as display 200, for outputting information to a user of the aerosol provision device 1. In this way, the information provision system 300 may also be configured to generate the information, and output/display the information on the user output device/display. As will be described, in accordance with certain embodiments of the disclosure, the information may comprise a prompt 202, such as a visual prompt, for the user to navigate to a predetermined location 204. In this way, and as will be described, by virtue of this prompt 202, the information provision system 300 may be configured to more optimally react to certain events occurring with respect to the aerosol provision device 1.

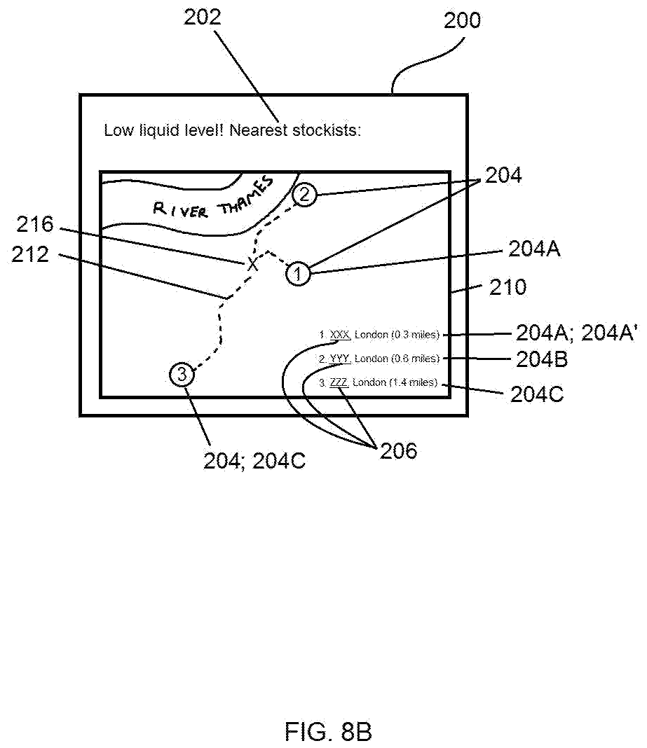

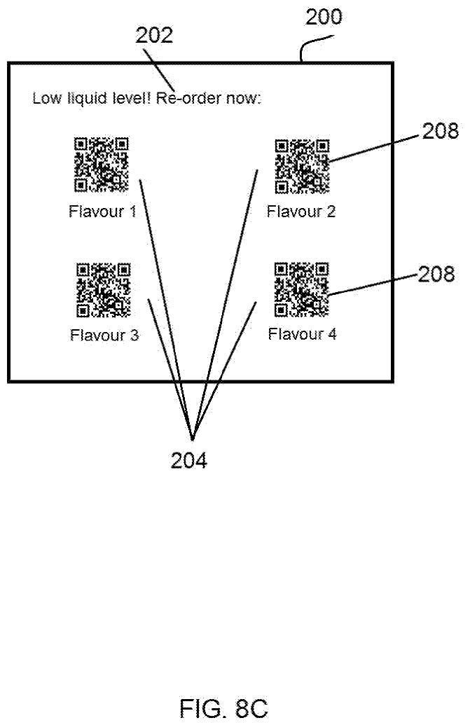

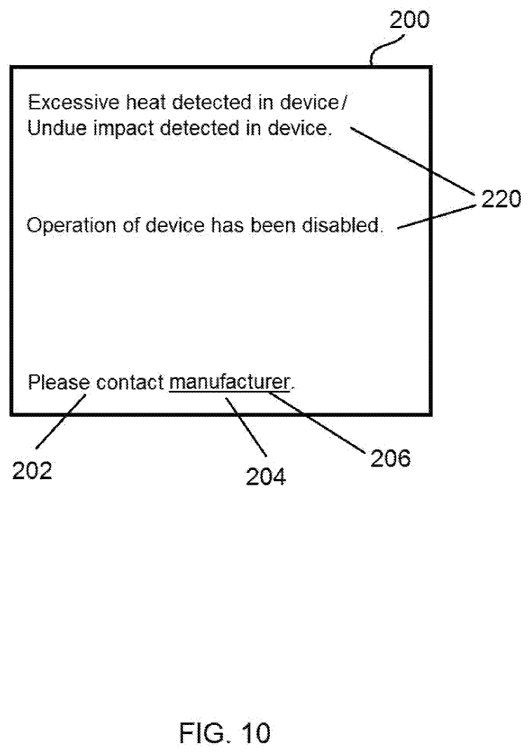

With respect to what the predetermined location 204 may be, in accordance with some embodiments, the predetermined location 204 may be a predetermined geographical location, such as a supplier, manufacturer, or stockist of the aerosol provision device 1, as shown best with reference to FIGS. 8A-8C. In this way therefore, by virtue of the aerosol provision device 1 outputting the prompt 202, this may allow for the aerosol provision device 1 to be more effectively restored to an intended working operation by the information provision system 300, for instance in situations when the information provision system 300 determines that the aerosol provision device is faulty (as shown with reference to the embodiment from FIG. 10), or is subject to an adverse condition (such as a predetermined low amount, or empty amount, of aerosolisable material in the aerosol provision device as shown with reference to the embodiments from FIGS. 8A-8C).

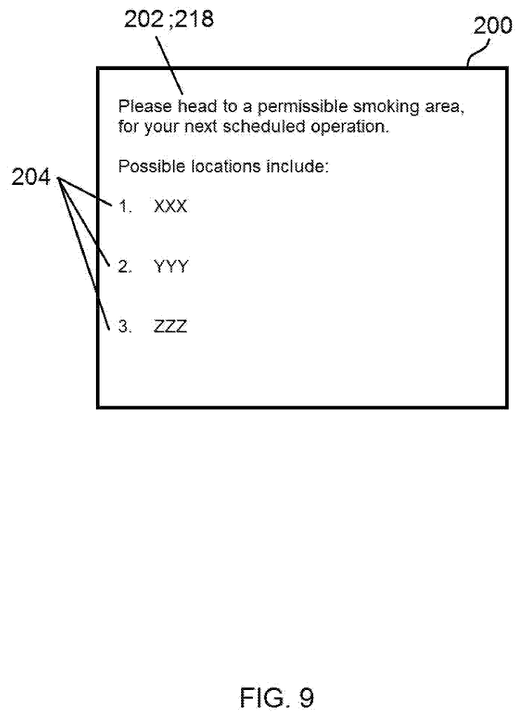

In accordance with some embodiments, any such predetermined geographical location may additionally/alternatively comprise a designated smoking area, or the location of an emergency service, such as the location of a police station, or hospital, or other medical establishment, as shown with reference to the embodiment from FIG. 9.

Tying in with the above embodiments, in accordance with some embodiments which may be used alongside, or in place, any of the above embodiments, the information provision system 300 may be configured to receive location data indicating the location of the aerosol provision device 1. It will be appreciated that this location data may be generated in a number of different ways, such as by way of the aerosol provision device 1 comprising at least one location sensor 91;95, such as an accelerometer or GPS (or similar navigation system) receiver, which is in communication with the control circuitry 18 of the aerosol provision device 1. Alternatively, the location data may be received by the information provision system 300 from a remote device, such as a user's phone or an electrical device 250 (as described below) which can communicate with the aerosol provision device 1, e.g. via a wireless connection protocol 270. Whatever the mechanism for receiving the location data, it may be seen that the information provision system 300 with this location data may be then configured to generate the information based on the location data, such to better optimise the operation of the information provision system 300 based on geographical considerations and nearby locations.

Continuing with embodiments where the location data is employed, in accordance with some very particular embodiments where the information comprise a prompt 202 for the user to navigate to a predetermined location 204, generating the information based on the location data may comprise the information provision system 300 determining from a plurality of different predetermined locations 204A;204B;204C which is a closest predetermined location 204A′ to the location of the aerosol provision device 1, and then selecting the closest predetermined location 204A′ from the plurality of different predetermined locations 204A;204B;204C as being the predetermined location 204. In practice, it will be appreciated the predetermined location 204, the closest predetermined location 204A′, and the plurality of different predetermined locations 204A;204B;204C, may each be all of the same type (e.g. all a supplier, or all a manufacturer, or all a stockist of the aerosol provision device 1). In this way for instance, in accordance with some embodiments, each predetermined location (namely each of the predetermined location, the closest predetermined location, and each of the plurality of different predetermined locations) might be a supplier of the aerosol provision device; a manufacturer of the aerosol provision device; a stockist of the aerosol provision device; a designated smoking area; or the location of an emergency service (such as a police station, a hospital, or other medical establishment). In accordance with these embodiments therefore, it will be appreciated that the information provision system 300 may operate to provide a prompt 202 for the user which identifies the nearest relevant location to them or their aerosol provision device 1. Such embodiments are illustrated, for example, with reference to the embodiments from FIGS. 8A and 8B, for instance.

As to the type of the predetermined location 204 which is output on the display 200 as part of the prompt 202, it will be appreciated that this may be varied by the information provision system 300 depending on a type of event from the information provision system 300. In this respect therefore, and in accordance with some embodiments, the information provision system 300 may be configured to generate the information in the event the information provision system 300 (or in the event the aerosol provision device 1) determines that a predetermined criterion is satisfied.

The predetermined criterion at its broadest level could relate to any measurable criterion relating to the aerosol provision device 1. In this respect for instance, and in accordance with some particular embodiments, the predetermined criterion may comprise a counter exceeding a predetermined counter number. In this respect for instance, the counter in accordance with some very particular embodiments could indicate the number of times in which any vaporiser 40 from the aerosol provision device 1 (or the aerosol provision device itself) is operated, or more particularly indicate the number of times in which any vaporiser 40 from the aerosol provision device 1 (or the aerosol provision device 1 itself) is operated since any cartridge 2 (if such a cartridge-based aerosol provision device is employed) from the aerosol provision device 1 was last connected to a body/control unit 4 from the aerosol provision device 1. In this way for instance, in response to the counter exceeding the predetermined counter number, this may be indicative of an amount of aerosolisable material in the aerosol provision device 1 being sufficiently low that a prompt 202 should be outputted comprising a predetermined location 204 in the form of the location of a (or the nearest) stockist of the aerosol provision device 1 and/or the location of a (or the nearest) stockist of the cartridge 2 for the aerosol provision device), such as a prompt in the forms illustrated in any of FIGS. 8A-8C for instance.

Appreciating the above embodiments, the information provision system 300 may also be configured to allow the predetermined counter number to be varied, such as in response to a command from the aerosol provision device 1, or in response to a command from the user. In this respect, in embodiments where the information provision system 300 is configured to vary the predetermined counter number, this may allow the predetermined counter number to account for different operating conditions, or to account for cartridges 2 which may be supplied in differing sizes (e.g. a smaller cartridge, which requires less uses of the vaporiser 40 to empty, compared with a relatively larger cartridge which requires more uses of the vaporiser 40 to empty).

Equally, the information provision system 300 may also be configured to allow the predetermined counter number to be varied automatically, e.g. as part of a predetermined operation. Such an operation may be, in accordance with some embodiments, in response to the aerosol provision device 1 detecting the vaporiser 40 exceeding a predetermined temperature. In this way, the information provision system 300 may be configured to vary (e.g. reduce) the predetermined counter number to facilitate the information comprising the prompt 202 being output sooner.

The information provision system 300 may also be configured to allow the predetermined counter number to be varied in response to a command from the user. In this way, the information provision system 300 may be of facilitation to those users who are looking to reduce their consumption of vaporised aerosolisable material from the aerosol provision device 1. In this respect for instance, the information provision system 300 may be configured to allow the predetermined counter number to be varied in response to a command from the user, for instance to be a predetermined counter number of their choosing, such as 1, 2, 3, 4, 5 or any other integer number.

Equally, the information provision system may equally be configured in accordance with some embodiments to additionally/alternatively reset the counter to zero once a predetermined time period has elapsed (e.g. an hour, 24 hours, a week, a month). In this way for instance, the user can then progressively/gradually reduce the predetermined counter number over time (e.g. over the course of a few months) to help facilitate their reduced operation of the aerosol provision device 1.

The provision of the prompt in this way can therefore help the information provision system 300 to better regulate the operation of the aerosol provision device 1.

In terms of some potential applications of the above embodiments, and also potentially other embodiments not necessarily employing such a counter, it may be appreciated that in accordance with some embodiments where the information comprise a prompt 202 for the user to navigate to a predetermined location 204, the predetermined location may be a website, or geographical location, for a stockist of a cartridge comprising a predetermined type. In this way, the prompt 202 may be helpful in facilitating the aerosol provision device to be restocked with a cartridge of such a predetermined type. By the term ‘type’ here, this may be understood as a cartridge which has a predetermined particular property. In this way therefore, and by way of some potential examples, it may be appreciated that the cartridge type in accordance with some embodiment may be a cartridge which comprises aerosolisable material comprising a predetermined flavour. Appreciably, this predetermined flavour may be the same as a flavour which is currently being used, or was last vaporised, by the aerosol provision device.

Equally, in some embodiments, the cartridge comprising a predetermined type might comprise a cartridge comprising a predetermined amount, or predetermined strength or concentration, of aerosolisable material. Again, any such property of the aerosolisable material might then be the same as the corresponding property of aerosolisable material which is currently being used, or was last vaporised, by the aerosol provision device, in so far as this might then allow an element of continuity in using the aerosol provision device with the same cartridge type as before.

Yet further still, the cartridge comprising a predetermined type might in some instances comprise a cartridge comprising a predetermined strength or concentration of active constituent (e.g. such as nicotine, caffeine, or any other active constituent as required—such as any of those described previously).

Where such a cartridge comprising a predetermined type is employed as part of the prompt, it will be appreciated in some instances that rather than perhaps being a cartridge type which is the same as the most-recent type of cartridge employed by the aerosol provision device, in some embodiments, the predetermined type of cartridge may appreciably comprise a cartridge type which has been designated as a favourite cartridge type. In such embodiments therefore, it may be that the user may have previously inputted information to the information provision system (or any aerosol provision device or user output device therefrom) which specifies this favourite cartridge type (such as a cartridge which comprises a predetermined concentration of nicotine—e.g. 0 mg/ml (nicotine free); 6 mg/ml; 12 mg/ml; or 18 mg/ml of nicotine; or perhaps a cartridge which comprises aerosolisable material comprising a predetermined flavour—such as cherry or mango). In this way, and in so far as the user is able to input information to the information provision system which specifies the favourite cartridge type, which might then relate to a type of cartridge which the user particularly prefers, the prompt may then be particularly helpful in prompting the user to restock the aerosol provision device with this preferred type of cartridge which is particularly preferable to the user.

That being said, it may be that in some embodiments, the predetermined type may comprise a cartridge type which is randomly selected—such as potentially from a plurality of different other cartridge types in some more limited embodiments. In this way, not only might this then improve the experience of the user from using the aerosol provision device over time—through the user then being more exposed to cartridges of different types (e.g. different flavours or concentrations), but this also may reduce the extent of any localised degradation of the working components from the aerosol provision device as a result of them being used with the same cartridge type each time (noting different cartridge types, such as those employing different flavours, or those employing active constituents of different concentrations, may potentially cause differing degradation patterns on the working components from the aerosol provision device over time). Appreciably as well, by providing a random cartridge type as part of the prompt, this may also encourage the user to try a different cartridge type to one which they might otherwise be accustomed. In this way, and by having the cartridge type randomly selected, potentially from a plurality of different other cartridge types, this may help with avoiding the user from using the same cartridge type each time, which may consequentially help with inhibiting the user from being desensitized to this (same) cartridge type over time.

Noting the above disclosures, it may also be seen that this disclosure may thus also provide for a method of outputting information to a user of an aerosol provision device for generating an aerosol, wherein the aerosol provision device comprises a cartridge of aerosolisable material, and wherein the aerosol provision device is configured to generate the aerosol using the aerosolisable material. In this way, the method may appreciably comprise: generating information comprising a prompt for a user of the aerosol provision device to:
i) navigate to a predetermined location, wherein the predetermined location is a website, or geographical location, for a stockist of a cartridge comprising a predetermined type, wherein the predetermined type comprises a cartridge type which is randomly selected from a plurality of different other cartridge types; and/or
ii) use a cartridge comprising a predetermined type, wherein the predetermined type comprises a cartridge type which is randomly selected from a plurality of different other cartridge types.

In this way, the method may then output the information on a user output device to allow the user to take action in response to the prompt.

Rather than a counter, and in accordance with some embodiments, the predetermined criterion may alternatively/additionally comprise at least one of a timer exceeding a predetermined time. Such a timer could be a number of different things, such as a timer indicating the time in which the vaporiser 40 from the aerosol provision device 1 was last operated. Equally, the timer in accordance with some embodiments could be a timer indicating the time since any cartridge 2 from the aerosol provision device 1 (where such a cartridge-based aerosol provision device is employed) was last connected to a body/control unit 4 from the aerosol provision device 1. In this way for instance, in response to the timer exceeding the predetermined time, this may be indicative of an amount of aerosolisable material in the aerosol provision device 1 being sufficiently low, or that the shelf life of the cartridge 2 may have expired. In which case, the information provision system 300 may then output the information comprising the prompt 202 on the display 200 for the user to navigate to a predetermined location 204 (such as the location of a (or the nearest) stockist of the cartridge 2 for the aerosol provision device 1), again as shown in the forms illustrated in FIGS. 8A-8C for instance.

Equally, the use of the timer in this instance could be particularly helpful for those seeking to control/meter the time spent using the aerosol provision device 1, such as those users who are looking to regulate or reduce their consumption of vaporised aerosolisable material from the aerosol provision device 1. In this way, when the timer exceeds the predetermined time, the information comprising the prompt 202 for the user to navigate to the predetermined location 204 (e.g. a designated smoking area, or the nearest designated smoking area) may be displayed, such as in the embodiment shown in FIG. 9. Appreciating these embodiments therefore, the information provision system 300 in some narrower embodiments may be further configured to allow the predetermined time to be varied in response to a command from the user, for instance to be a predetermined time of their choosing, such as 1 hour, 2 hours, 4 hours, 8 hours, 12 hours, or 24 hours. Equally, the information provision system 300 may be configured in accordance with some embodiments to additionally/alternatively reset the timer (e.g. to zero) once the timer exceeds the predetermined time. The provision of the information comprising this prompt 202 in this way can therefore help the information provision system 300 to better regulate the operation of the aerosol provision device 1 in line with a user's requirements.

For completeness, it is noted in the above instances that any predetermined location 204 need not necessarily be a geographical location, and so could also/alternately comprise a virtual location. This may be achieved in accordance with some embodiments, for instance, through the information comprising a hyperlink 206 or bar code 208—such as a liner barcode or a matrix barcode (e.g. a QR code, as shown in the embodiment of FIG. 8C). Such a virtual location might comprise, for illustrative purposes, a website of a supplier, manufacturer, or stockist of the aerosol provision device 1, and/or of any employed cartridge 2 of the aerosol provision device 1, again as shown in the embodiment of FIG. 8C.

With respect to the location of the display 200 (or more generally the user output device) from the information provision system 300, as shown best with reference to FIG. 7, it is envisaged in some embodiments that the display (or user output device) 200 may form part of the aerosol provision device 1, such that the aerosol provision device 1 comprises the user output device (e.g. the display 200). In this way, the information provision system 300 may more effectively allow the user to action any prompts 202 whilst the aerosol provision device 1 is being operated whilst in the user's hand or mouth.

Equally however, in accordance with some embodiments, the information provision system 300 may further comprise an electrical device 250 configured to communicate with the aerosol provision device 1, wherein the electrical device 250 comprises the user output device (e.g. the display 200). In this way, the information provision system 300 can more flexibly output prompts 202 to other locations beyond just the aerosol provision device 1, which may be particularly helpful in instances when the aerosol provision device 1 is not in the user's hand or line of sight. As to what such an electrical device 250 might be, it is envisaged that this may comprise any form of electrical device which might operably communicate with the aerosol provision device 1, such as (and certainly not limited to) any of a portable device, such as a tablet computer, smartphone, portable computer, or even a desktop computer, server or other multipurpose computing device. As required, it will be appreciated that the electrical device 250 may be operable to communicate with the aerosol provision device 1, such as wirelessly via a wireless connection protocol 270. In this case therefore, appreciably the electrical device 250 may then also comprise a wireless transmitter/receiver/transceiver 252, as appropriate, to facilitate any such wireless communication with the aerosol provision device 1 (which equally may then also comprise a wireless transmitter/receiver/transceiver 97 in communication with the control circuitry 18).

In accordance with some embodiments, any such electrical device 250 could also comprise a docking station 260 for receiving the aerosol provision device 1, as shown with reference to FIG. 7. Such a docking station 260, which can often be used to allow data or information to be transferred off from the aerosol provision device 1, and/or used to provide power for recharging the aerosol provision device 1 (e.g. by way of the charging port 24 from the aerosol provision device 1, in accordance with some embodiments), can then be operable to conveniently act as a source for the outputted information comprising the prompt 202 relating to the aerosol provision device 1, in a way which allows the prompt 202 to be more readily discerned/viewable by the user (e.g. when the user comes to dock/undock the aerosol provision device 1 from the docking station 260).

As to the nature of the prompt 202, it will be appreciated that the prompt 202 may comprise a variety of different forms for prompting the user to navigate to a predetermined location 204. For instance, in accordance with some embodiments, such as embodiments where the predetermined location is a geographical location, the prompt 202 may indicate the position of the predetermined location 204. In this respect, and in accordance with some particular embodiments, the prompt may comprise a graphical representation (such as a map 210) showing the predetermined location 204, or comprise a set of visual directions 212 for navigating to the predetermined location 204, which may be further based on location data indicating the location 216 of the aerosol device 1 or of the user. Appreciably, in accordance with some embodiments, appreciably the location data may be either determined by the information provision system 300 itself, or received by the information provision system 300.

As noted above, it is envisaged that in some embodiments, the information provision system 300 may be configured to generate, and output, the information comprising the prompt 202 for the user to navigate to a predetermined location 204, such as in instances where a timer exceeds a predetermined time, which may be indicative of it being time for the user to next operate the aerosol provision device 1, e.g. as part of a program to control/regulate the operation of their aerosol provision device 1. Mindful of such embodiments, and potentially other embodiments, the information may further comprise a suggestion 218 for the user to operate the aerosol provision device 1 (as shown in the embodiment of FIG. 9).

This being the case, it will be appreciated that the information output to the user via the user output device, such as the display 200, may comprise other indications depending on the reason for the associated information being generated. Mindful of this, it will be appreciated that in accordance with some embodiments, the information may further comprise any of: an indication that a software update is available for the aerosol provision device; an indication that the aerosol provision device is faulty 220 (as shown in the embodiment of FIG. 10); an indication that the aerosol provision device 1 has not been operated for a predetermined period of time; and/or even a suggestion to contact the emergency services. In accordance with these embodiments, it will be appreciated that the information may be generated in response to the information provision system 300 determining that a relevant predetermined criterion is satisfied.

For instance, in embodiments where the information comprises an indication that a software update is available for the aerosol provision device, this may be in response to the information provision system 300 determining, or receiving a signal indicating, that the software for operating the aerosol provision device 1, or that any software for operating the control circuitry 18, is outdated.

Equally, in embodiments where the information comprises an indication that the aerosol provision device 1 has not been operated for a predetermined period of time, in accordance with some embodiments thereof, this indication may be used in conjunction with a prompt 202 for a user to navigate to designated smoking area (e.g. as shown in the embodiment of FIG. 9), and/or may be generated in response to a timer exceeding a predetermined time (which may be indicative of when the user last operated the aerosol provision device 1).

Appreciably as well, in embodiments where the information comprises a suggestion to contact the emergency services, and/or an indication that the aerosol provision device is faulty 220, this information may be generated in response to determining that a predetermined criterion is satisfied, such as (and certainly not limited to) a determination that an adverse event has occurred in or with respect to the aerosol generating device 1.

For detecting such an adverse event, the aerosol generating device 1 may comprise at least one sensor 91 for generating sensor data. Purely by way of examples, such a sensor(s) could comprise a temperature sensor 93 for sensing a temperature of the vaporiser 40, or an accelerometer 95 for detecting an acceleration experienced by the aerosol generating device 1. In this way, the aerosol generating device 1 (and/or its control circuitry 18) may be configured to receive the sensor data from the sensor 91;93;95, and determine whether or not the predetermined criterion is satisfied using this sensor data. In these example embodiments for instance, the predetermined criterion being satisfied may comprise the sensor data being indicative of a temperature of the vaporiser 40 exceeding a predetermined temperature, or the sensor data being indicative of an acceleration which exceeds a predetermined acceleration, such as an acceleration in excess of 10G or 20G (which could be indicative of the aerosol provision device 1 being broken, or subjected to a collision or some other damaging conditions). Appreciating this disclosure therefore, it will be understood that other predetermined conditions may be used to determine when the information may be generated, such that the acceleration and temperature embodiments described above are not intended to be exhaustive.

Turning to the duration of any information/prompt 202 which is output from the user output device, such as the display 200, it is envisaged that the information provision system 300 may be configured to display the information on the display 200 until the information provision system 300 receives a signal from the user to no longer display the information on the display 200. Equally, the information provision system 300 may also/alternatively be configured to display the information for only a predetermined period of time, such to both encourage the user to consider the information and any accompanying prompt 202 in a timely fashion, whilst also not unduly cluttering the display 200 with the information for longer than necessary. Appreciably therefore, the extent of this predetermined time may be configured to be varied by the information provision system 300 depending on the information which is displayed (or more generally, output, in the case of a user output device). For instance, in accordance with some example embodiments, the predetermined period of time may be any of: no more than 30 seconds; no more than 60 seconds; no more than 5 minutes; no more than 10 minutes; no more than 30 minutes; no more than an hour; no more than 12 hours; no more than a day; or no more than a week.

Related to the above, in accordance with some embodiments, to best encourage the user to consider the displayed information in a timely fashion, or to more reliably act on the information, the information provision system 300 may in accordance with some embodiments be configured to generate the information at a random time or in response to a signal which is randomly generated, such as based on a random number generator function or in response to the information provision system 300 receiving a signal which is randomly generated. In this respect for instance, in some embodiments thereof the information may comprise a prompt 202 for the user to navigate to a predetermined location 204, such as a stockist of the aerosol provision device 1, or a stockist of a cartridge(s) 2 for the aerosol provision device 1. In this instance, the information may also comprise a suggestion to try a particular or predetermined flavour of aerosolisable material (or cartridge 2 containing such a flavour of aerosolisable material), or to try a cartridge 2 of a particular predetermined size. In accordance with these embodiments therefore, appreciating that the information provision system 300 is configured to generate the information at a random time, this may make it more likely for the user to consider and act on the information, compared with if the information was expected at a particular predetermined time by the user. In accordance with such embodiments as well, in so far as the information provision system 300 may be further configured to display/output the information for only a predetermined period of time, this may yet further encourage/incentivise the user to act on the information more often than they otherwise might do if these technical limitations were not imposed on the information generation by the information provision system 300.

Appreciating the foregoing, there has accordingly been described an information provision system comprising:
an aerosol provision device for generating an aerosol; and
a user output device for outputting information to a user of the aerosol provision device;
wherein the information provision system is configured to generate the information, and output the information on the user output device, wherein the information comprises a prompt for the user to navigate to a predetermined location.

There has also been described a method of outputting information to a user of an aerosol provision device for generating an aerosol, the method comprising:
generating information comprising a prompt for a user of the aerosol provision device to navigate to a predetermined location; and
outputting the information on a user output device.

There has also been described an information provision system 300 comprising an aerosol provision device 1 for generating an aerosol, and a user output device 200 for outputting information to a user of the aerosol provision device 1. The information may comprise a prompt 202 for the user to navigate to a predetermined location 204, which may be a virtual location or a geographical location. The information provision system 300 may be configured to generate the information in the event the information provision system 300 determines that a predetermined criterion is satisfied. Such a predetermined criterion could be the information provision system 300 detecting that a timer exceeds a predetermined time, or possibly the information provision system 300 determining that sensor data from a sensor 91;93;95 of the aerosol generating device 1 is indicative of an adverse event.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

For instance, although the present disclosure has been described with reference to the information comprising a prompt for the user to navigate to a predetermined location, it will be appreciated that the information in accordance with embodiments need not necessarily comprise such a prompt, or a prompt which specifically is a prompt for the user to navigate to a predetermined location. Appreciably therefore, in accordance with some broader embodiments, the information could alternatively/additionally comprise some other information, such as, but certainly limited, any of the suggestions or indications described herein.

Equally, although the present disclosure has been described with reference to an information provision system comprising a user output device in the form of a display 200 for outputting the generated information to a user of the aerosol provision device, it will be appreciated that in accordance with some embodiments, the information provision system 300 may additionally/alternatively comprise other forms of user output device not necessarily in the form of a display 200. In this way, and although not necessarily, the information may then comprise any of the suggestions or indications described herein, and/or a prompt 202, such as a prompt (in lieu of a visual prompt), for the user to navigate to a predetermined location 204, or to act as a prompt 202 in respect of any other potential action(s) described herein.

In this way therefore, and in accordance with certain embodiments described herein, there is also provided an information provision system comprising:
an aerosol provision device for generating an aerosol; and
a user output device for outputting information to a user of the aerosol provision device, wherein the information provision system is configured to generate the information, and output the information through the user output device, wherein the information comprises a prompt for the user to navigate to a predetermined location.

There is thus also provided a method of outputting information to a user of an aerosol provision device for generating an aerosol, the method comprising:
generating information comprising a prompt for a user of the aerosol provision device to navigate to a predetermined location; and
outputting the information on a user output device.

There has also been described a method of outputting information to a user of an aerosol provision device for generating an aerosol, wherein the aerosol provision device comprises a cartridge of aerosolisable material, and wherein the aerosol provision device is configured to generate the aerosol using the aerosolisable material, wherein the method comprises:
generating information comprising a prompt for a user of the aerosol provision device to:
   i) navigate to a predetermined location, wherein the predetermined location is a website, or geographical location, for a stockist of a cartridge comprising a predetermined type, wherein the predetermined type comprises a cartridge type which is randomly selected from a plurality of different other cartridge types; and/or
   ii) use a cartridge comprising a predetermined type, wherein the predetermined type comprises a cartridge type which is randomly selected from a plurality of different other cartridge types; and
output the information on a user output device.

Such a method may thus help with reducing the extent of any localised degradation of the working components from the aerosol provision device as a result of them being used with the same cartridge type each time, and/or may also help with inhibiting the user from being desensitized to this (same) cartridge type over time. With respect to any such method which may be employed, it may be appreciated that this may then appreciably comprise any of the other features employed by the claims or clauses as recited below, for instance, as required, such as i) the plurality of different other cartridge types each comprising a different flavouring material and/or comprising a different active constituent), and/or ii) the user output device comprising a display, wherein the information is displayed on the display—purely by way of example.

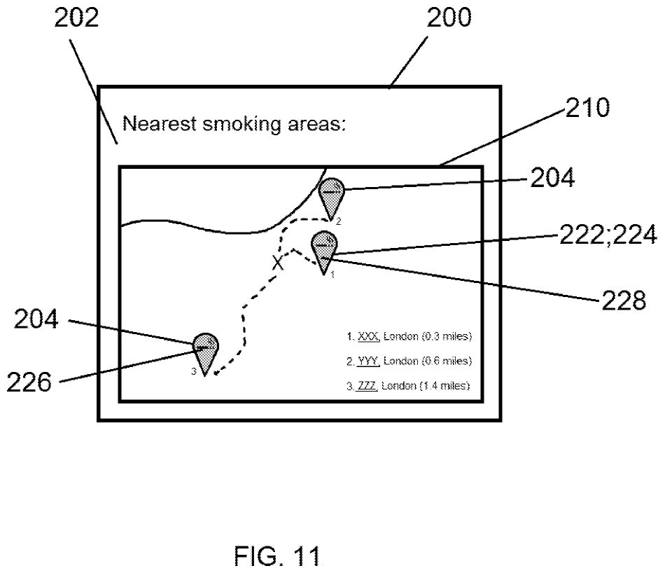

With respect to the present disclosure, in so far as any prompt 202 may be provided, it may be appreciated that in accordance with some embodiments, the prompt 202 as noted previously may in some cases comprise a graphical representation, such as a map 210, showing the predetermined location 204. Such a map 210 is shown for instance in the embodiments of FIG. 8B and also FIGS. 11-13. In this way, the user may be able to then more easily see, in a geographical sense, where the relevant predetermined location 204 is.

In such embodiments, and potentially others, the prompt 202 may further comprise a set of visual directions 212 for navigating to the predetermined location 204, based on location data indicating the location of the aerosol provision device or the user. Again, such an application of the prompt 204 is illustrated in FIG. 8B, where the visual directions 212 comprise a path which is displayed, or overlaid, on the map 210.

Noting the above, it will be appreciated that in some embodiments, the prompt 202 may comprise a location indicator 222, such as potentially a pin 224 or some other type of visual marker, for indicating the location of the predetermined location 204 on the graphical representation (such as the map 210), as illustrated in the embodiments of FIGS. 11-13 for instance.

Where such a location indicator 222 is employed, in accordance with some embodiments, the location indicator 222 may be visually coded in some form to help indicate a characteristic or identity of the predetermined location 204 (such as whether the predetermined location 204 is a designated smoking area, or potentially a stockist of the aerosol provision device, or even an emergency service (such as a police station, a hospital, or other medical establishment), or perhaps even a leisure facility (such as a restaurant, bar, cinema, or a pub), which in some narrower embodiments might be a facility which allows smoking).

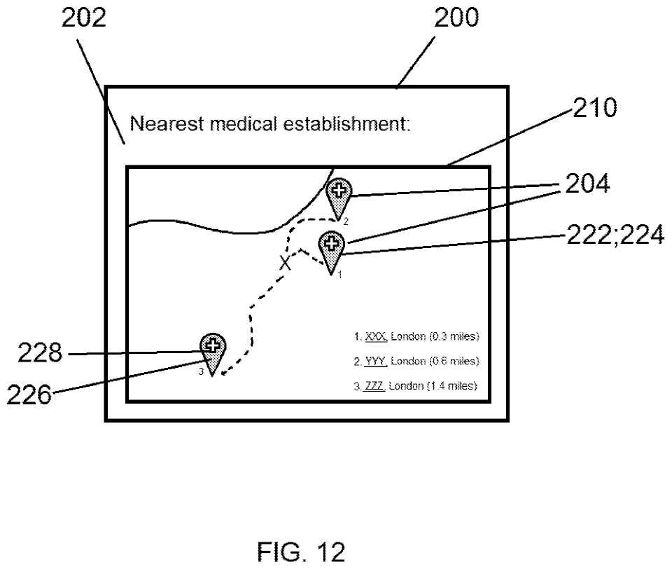

In this way therefore, and in accordance with some embodiments, the location indicator 222 may in some instances comprise a predetermined colour 226, and/or a predetermined marking 228, for indicating a characteristic or identity of the predetermined location 204, e.g.:
i) a smoking symbol on a grey background in the embodiment of FIG. 11 in the case of the predetermined location 204 comprising a designated smoking area;
ii) a health symbol, such as a plus or crescent, on a blue or cyan background in the embodiment of FIG. 12 in the case of the predetermined location 204 comprising a hospital or a medical establishment; and/or
iii) a knife/fork symbol on a red/pink background in the case of the predetermined location 204 comprising a restaurant; a drinking vessel symbol on a green/lime background in the case of the predetermined location 204 comprising a bar or a pub; or perhaps a play symbol or a picture of a cinema on an orange background in the case of the predetermined location 204 comprising a cinema.

It will be appreciated that any particular colour and/or marking could be attributed to any particular type of predetermined location, and that the above colour/marking examples are not intended to be limiting in any way necessarily.

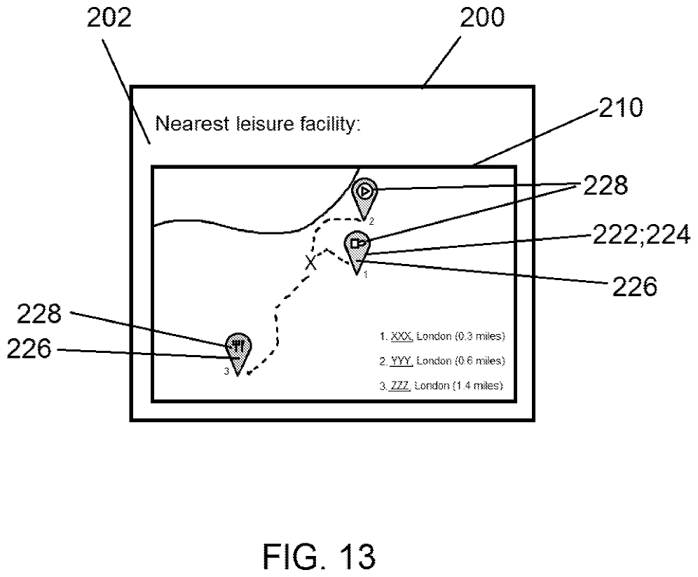

Thus by tailoring the location indicator 222 to comprise a predetermined colour 226, and/or a predetermined marking 228, which indicates a characteristic or identity of the predetermined location 204, this may thus make it easier for the user to identify the pertinent location indicator 222 from the prompt 202. This may especially be so, in instances where the prompt 202 is displaying multiple location indicators 222 relating to different types of location—as shown in the embodiment of FIG. 13 for instance, such that having the different colours 226 or markings 228 for the different types of predetermined location 204 may make it that much easier for the user to identify the particular type of location they require.

### First Set of Clauses

1. An information provision system comprising:
   an aerosol provision device for generating an aerosol; and
   a user output device for outputting information to a user of the aerosol provision device;
   wherein the information provision system is configured to generate the information, and output the information on the user output device, wherein the information comprises a prompt for the user to navigate to a predetermined location.
2. An information provision system according to clause 1, wherein the information comprises a hyperlink or barcode.
3. An information provision system according to any preceding clause, wherein the predetermined location is a website, or geographical location, for a supplier or manufacturer of the aerosol provision device.
4. An information provision system according to any preceding clause, wherein the predetermined location is a website, or geographical location, for a stockist of the aerosol provision device.
5. An information provision system according to any preceding clause, wherein the aerosol provision device comprises a cartridge of aerosolisable material, wherein the aerosol provision device is configured to generate the aerosol using the aerosolisable material.
6. An information provision system according to clause 5, wherein the predetermined location is a website, or geographical location, for a stockist of the cartridge.
7. An information provision system according to any preceding clause, wherein the predetermined location is a designated smoking area.
8. An information provision system according to any preceding clause, wherein the information provision system is configured to receive location data indicating the location of the aerosol provision device, and is configured to generate the information based on the location data.
9. An information provision system according to any preceding clause, wherein the information provision system is configured to determine location data indicating the location of the aerosol provision device, and is configured to generate the information based on the location data.
10. An information provision system according to any preceding clause, wherein the information further comprises an indication that a software update is available for the aerosol provision device.
11. An information provision system according to any preceding clause, wherein the information further comprises a suggestion for the user to operate the aerosol provision device.
12. An information provision system according to any preceding clause, wherein the information further comprises an indication that the aerosol provision device is faulty.
13. An information provision system according to any preceding clause, wherein the information further comprises a suggestion to contact the emergency services.
14 An information provision system according to any preceding clause, wherein the information further comprises an indication that the aerosol provision device has not been operated for a predetermined period of time.
15. An information provision system according to any preceding clause, wherein the user output device is configured to output the information for only a predetermined period of time.
16. An information provision system according to any preceding clause, wherein the information provision system is configured to generate the information in the event the information provision system determines that a predetermined criterion is satisfied.
17. An information provision system according to clause 15, wherein the predetermined criterion comprises a counter exceeding a predetermined counter number.
18. An information provision system according to clause 15 or 16, wherein the predetermined criterion comprises the aerosol provision device being operated for a predetermined number of times.
19. An information provision system according to any preceding clause, wherein the information provision system is configured to generate the information at a random time.
20. An information provision system according to any preceding clause, wherein the aerosol provision device comprises the user output device.
21. An information provision system according to any of clauses 1-19, further comprising an electrical device configured to communicate with the aerosol provision device, wherein the electrical device comprises the user output device.
22. An information provision system according to clause 20, wherein the electrical device comprises a docking station for receiving the aerosol provision device.
23. An information provision system according to any preceding clause, wherein the user output device comprises a display, wherein the information provision system is configured to generate the information, and display the information on the display.
24. An information provision system according to any preceding clause, wherein the prompt comprises a graphical representation showing the predetermined location.
25. An information provision system according to clause 24, wherein the predetermined location comprises a predetermined geographical location.
26. An information provision system according to clause 24 or 25, wherein the graphical representation comprises a map.
27. An information provision system according to any preceding clause, wherein the prompt comprises a set of visual directions for navigating to the predetermined location.
28. An information provision system according to clause 27, when further dependent on clause 26, wherein the set of visual directions comprise a path which is displayed, or overlaid, on the map.
29. An information provision system according to any of clauses 24-28, wherein the prompt comprise a location indicator for indicating the location of the predetermined location on the graphical representation.
30 An information provision system according to clause 29, wherein the location indicator comprises a pin.
31. An information provision system according to clause 29 or 30, wherein the location indicator comprises a predetermined colour for indicating a characteristic or identity of the predetermined location.
32. An information provision system according to any of clauses 28-30, wherein the location indicator comprises a predetermined marking for indicating a characteristic or identity of the predetermined location.
33. An information provision system according to any preceding clause, wherein the predetermined location is a website, or geographical location, for a stockist of a cartridge comprising a predetermined type.
34. An information provision system according to clause 33, wherein the cartridge comprising the predetermined type comprises a cartridge comprising aerosolisable material comprising a predetermined flavour.
35. An information provision system according to clause 33 or 34, wherein the cartridge comprising the predetermined type comprises a cartridge comprising a predetermined amount of aerosolisable material.
36. An information provision system according to any of clauses 33-35, wherein the cartridge comprising the predetermined type comprises a cartridge comprising a predetermined strength or concentration of aerosolisable material.
37. An information provision system according to any of clauses 33-36, wherein the cartridge comprising the predetermined type comprises a cartridge comprising a predetermined strength or concentration of active constituent, such as nicotine.
38. An information provision system according to any of clauses 33-37, wherein the predetermined type comprises a cartridge type which has been designated as a favourite cartridge type.
39. An information provision system according to any of clauses 33-38, wherein the predetermined type comprises a cartridge type which is randomly selected from a plurality of different other cartridge types.
40. An information provision system according to any of clauses 33-39, wherein the information provision system is configured for allowing a user to input information to the information provision system which specifies the favourite cartridge type.
41. A method of outputting information to a user of an aerosol provision device for generating an aerosol, the method comprising:
   generating information comprising a prompt for a user of the aerosol provision device to navigate to a predetermined location; and
   outputting the information on a user output device.
42. A method according to clause 41, wherein the method further comprises:
   receiving location data indicating a location of the aerosol provision device; and
   generating the information based on the location data.
43. A method according to clause 41 or 42, wherein the method further comprises:
   determining that a predetermined criterion is satisfied; and
   generating the information in response to determining that the predetermined criterion is satisfied.
44. A method according to any of clauses 41-43, wherein the method further comprises:
   receiving information which specifies a favourite cartridge type for use with the aerosol provision device,
   wherein the predetermined location is a website, or geographical location, for a stockist of a cartridge comprising a predetermined type, wherein the predetermined type comprises the favourite cartridge type.
45. A method of outputting information to a user of an aerosol provision device for generating an aerosol, wherein the aerosol provision device comprises a cartridge of aerosolisable material, and wherein the aerosol provision device is configured to generate the aerosol using the aerosolisable material, wherein the method comprises:
   generating information comprising a prompt for a user of the aerosol provision device to:
      i) navigate to a predetermined location, wherein the predetermined location is a website, or geographical location, for a stockist of a cartridge comprising a predetermined type, wherein the predetermined type comprises a cartridge type which is randomly selected from a plurality of different other cartridge types; and/or
      ii) use a cartridge comprising a predetermined type, wherein the predetermined type comprises a cartridge type which is randomly selected from a plurality of different other cartridge types; and
   output the information on a user output device.

### Second Set of Clauses

1. An information provision system comprising:
   an aerosol provision device for generating an aerosol; and
   a user output device for outputting information to a user of the aerosol provision device, wherein the user output device comprises a display;
   wherein the information provision system is configured to generate the information, and display the information on the display from the user output device, wherein the information comprises a prompt for the user to navigate to a predetermined, geographical, location;
   wherein the prompt comprises a graphical representation, such as a map, showing the predetermined location; and
   wherein the prompt further comprises a set of visual directions for navigating to the predetermined location, based on location data indicating the location of the aerosol provision device or the user;
   wherein the location data is configured to be either i) determined by the information provision system, or ii) received by the information provision system.
2. An information provision system according to clause 1, wherein the information further comprises a hyperlink or barcode.
3. An information provision system according to any preceding clause, wherein the predetermined location is a geographical location for a supplier or manufacturer of the aerosol provision device.
4. An information provision system according to any preceding clause, wherein the predetermined location is a geographical location for a stockist of the aerosol provision device.
5. An information provision system according to any preceding clause, wherein the aerosol provision device comprises a cartridge of aerosolisable material, wherein the aerosol provision device is configured to generate the aerosol using the aerosolisable material.
6. An information provision system according to clause 5, wherein the predetermined location is a geographical location for a stockist of the cartridge.
7. An information provision system according to any preceding clause, wherein the predetermined location is a designated smoking area.
8. An information provision system according to any preceding clause, wherein the information provision system is configured to receive location data indicating the location of the aerosol provision device, and is configured to generate the information based on the location data.
9. An information provision system according to any preceding clause, wherein the information further comprises an indication that a software update is available for the aerosol provision device.
10. An information provision system according to any preceding clause, wherein the information further comprises a suggestion for the user to operate the aerosol provision device.
11. An information provision system according to any preceding clause, wherein the information further comprises an indication that the aerosol provision device is faulty.
12. An information provision system according to any preceding clause, wherein the information further comprises a suggestion to contact the emergency services.
13. An information provision system according to any preceding clause, wherein the information further comprises an indication that the aerosol provision device has not been operated for a predetermined period of time.
14. An information provision system according to any preceding clause, wherein the user output device is configured to output the information for only a predetermined period of time.
15. An information provision system according to any preceding clause, wherein the information provision system is configured to generate the information in the event the information provision system determines that a predetermined criterion is satisfied.
16. An information provision system according to clause 15, wherein the predetermined criterion comprises a counter exceeding a predetermined counter number.
17. An information provision system according to clause 15 or 16, wherein the predetermined criterion comprises the aerosol provision device being operated for a predetermined number of times.
18. An information provision system according to any preceding clause, wherein the aerosol provision device comprises the user output device.
19. An information provision system according to any of clauses 1-18, further comprising an electrical device configured to communicate with the aerosol provision device, wherein the electrical device comprises the user output device.
20 An information provision system according to any preceding clause, wherein the set of directions comprises a path, on the graphical representation, to the predetermined location from the location of the aerosol provision device or from the location of the user.
21. A method of outputting information to a user of an aerosol provision device for generating an aerosol, the method comprising:
   receiving, or determining, location data indicating a location of the aerosol provision device or a location of the user;
   generating information, based on the location data, comprising a prompt for a user of the aerosol provision device to navigate to a predetermined geographical location; and
   displaying the information on a display from a user output device, wherein displaying the information on the display from the user output device further comprises:
      displaying a prompt comprising a graphical representation, such as a map, showing the predetermined geographical location, wherein the prompt further comprises a set of visual directions for navigating to the predetermined geographical location from the location of the aerosol provision device or from the location of the user.
22. The method according to clause 21, wherein displaying the information on the display from the user output device further comprises indicating the distance to the predetermined geographical location from the location of the aerosol provision device or from the location of the user.
23. The method according to clause 21 or 22, wherein the set of directions comprises a path, on the graphical representation, to the predetermined location from the location of the aerosol provision device or from the location of the user.
24 A method according to any of clauses 20-23, wherein the method further comprises:
   determining that a predetermined criterion is satisfied; and
   generating the information in response to determining that the predetermined criterion is satisfied.

1. An information provision system comprising:
an aerosol provision device for generating an aerosol; and
a user output device for outputting information to a user of the aerosol provision device;
wherein the information provision system is configured to generate the information, and output the information on the user output device for only a predetermined period of time, wherein the information comprises a prompt for the user to navigate to a predetermined location.

2. (canceled)

3. An information provision system according to claim 1, wherein the predetermined location is a website, or geographical location, for a supplier or manufacturer or stockist of the aerosol provision device.

4. (canceled)

5. An information provision system according to claim 1, wherein the aerosol provision device comprises a cartridge of aerosolisable material, wherein the aerosol provision device is configured to generate the aerosol using the aerosolisable material.

6. An information provision system according to claim 5, wherein the predetermined location is a website, or geographical location, for a stockist of the cartridge.

7. (canceled)

8. An information provision system according to claim 1, wherein the information provision system is configured to receive location data indicating the location of the aerosol provision device, and is configured to generate the information based on the location data.

9. (canceled)

10. An information provision system according to claim 1, wherein the information further comprises a suggestion for the user to operate the aerosol provision device.

11. An information provision system according to claim 1, wherein the information further comprises an indication that the aerosol provision device is faulty.

12. An information provision system according to claim 1, wherein the information further comprises a suggestion to contact the emergency services.

13. (canceled)

14. An information provision system according to claim 1, wherein the information provision system is configured to generate the information in the event the information provision system determines that a predetermined criterion is satisfied.

15. An information provision system according to claim 14, wherein the predetermined criterion comprises a counter exceeding a predetermined counter number.

16. An information provision system according to claim 14, wherein the predetermined criterion comprises the aerosol provision device being operated for a predetermined number of times.

17-24. (canceled)

25. An information provision system according to claim 1, wherein the prompt comprises a set of visual directions for navigating to the predetermined location.

26. An information provision system according to claim 25, wherein the set of visual directions comprise a path which is displayed, or overlaid, on the map.

27. An information provision system according to claim 22, wherein the prompt comprise a location indicator for indicating the location of the predetermined location on the graphical representation.

28. An information provision system according to claim 27, wherein the location indicator comprises a pin.

29. (canceled)

30. An information provision system according to claim 27, wherein the location indicator comprises a predetermined marking for indicating a characteristic or identity of the predetermined location.

31-38. (canceled)

39. A method of outputting information to a user of an aerosol provision device for generating an aerosol, the method comprising:
generating information comprising a prompt for a user of the aerosol provision device to navigate to a predetermined location; and
outputting the information on a user output device for only a predetermined period of time.

40. A method according to claim 39, wherein the method further comprises:
receiving location data indicating a location of the aerosol provision device; and
generating the information based on the location data.

41. A method according to claim 39, wherein the method further comprises:
determining that a predetermined criterion is satisfied; and
generating the information in response to determining that the predetermined criterion is satisfied.

42. A method according to claim 39, wherein the method further comprises:
receiving information which specifies a favourite cartridge type for use with the aerosol provision device,
wherein the predetermined location is a website, or geographical location, for a stockist of a cartridge comprising a predetermined type, wherein the predetermined type comprises the favourite cartridge type.
